(19) United States
(12) Patent Application Publication
(10) Pub. No.: US 2016/0047115 A1
(43) Pub. Date: Feb. 18, 2016

(54) THERMAL CATCH BASIN GRATE

(71) Applicant: Brenda SADLER, Calgary (CA)

(72) Inventor: Brenda SADLER, Calgary (CA)

(21) Appl. No.: 14/827,264

(22) Filed: Aug. 14, 2015

Related U.S. Application Data
(63) Continuation-in-part of application No. 14/460,960, filed on Aug. 15, 2014.

(51) Int. Cl. E03F 5/14; E03F 9/00; B01D 35/02; B01D 35/28; B01D 35/18

(52) U.S. Cl. CPC E03F 5/14; B01D 35/28; B01D 35/18; B01D 35/02; E03F 9/00

(57) ABSTRACT

Disclosed herein are catch basin grate covers comprising at least one heating block and/or at least one heating rod in thermal communication with a grate cover, wherein the grate cover comprises a) a base; b) a frame; c) a grate; and d) a power source in electric communication with the at least one heating block and/or at least one heating rod. Also disclosed are methods of preventing the clogging of a catch basin grate cover due to ice, the method comprising applying electricity to the heating block of the grate cover, whereby the resulting heat from the heating block causes the ice to thaw, thereby unclogging the catch basin grate cover.

### CROSS REFERENCE TO RELATED APPLICATION

This application is a continuation-in-part of applicant's co-pending application Ser. No. 14/609,960, filed Aug. 15, 2014, the entire contents of which is hereby expressly incorporated by reference herein.

### FIELD OF THE INVENTION

The present disclosure is in the field of grates covering drainage pipes.

### BACKGROUND OF THE DISCLOSURE

A catch basin is a basin that on one side is open to the elements, and on another side connects with a sewer or drainage system. Typically, catch basins are located at a low point in a drainage plane, for example in a park, or at a street corner, or where a street has a dip. Water from the rain, snow, or irrigation flows into the catch basin and drains through the sewer system. Normally, a catch basin is covered by a grated plate that prevents large debris, such as tree branches or garbage, to fall into the catch basin and clog the drainage system. During the cold winter months, water on or around the grated plate freezes and prevents the normal drainage of melted snow. This causes for water to accumulate and freeze over the grated plate, which poses a danger to anyone walking or driving in the affected area. Therefore, there is a need in the art for a mechanism to prevent the catch basin grate from freezing in winter.

### SUMMARY OF THE INVENTION

Disclosed herein are catch basin grate covers comprising at least one heating block and/or at least one heating rod in thermal communication with a grate cover, wherein the grate cover comprises a) a base; b) a frame; c) a grate; and d) a power source in electric communication with the at least one heating block and/or at least one heating rod. Also, disclosed herein is a method of preventing the clogging of a catch basin grate cover due to ice, the method comprising applying electricity to the heating block of the catch basin grate covers herein, wherein the resulting heat from the heating block causes the ice to thaw, thereby unclogging the catch basin grate cover.

### BRIEF DESCRIPTION OF THE DRAWINGS

FIG. 1 is an illustration of an exploded view of a first configuration of a catch basin grate.

FIG. 2 is an illustration of a side view of the first configuration of a catch basin grate in a street gutter.

FIG. 3 is an illustration of an exploded view of a second configuration of a catch basin grate.

FIG. 4 is an illustration of a side view of the second configuration of a catch basin grate in a street gutter.

FIG. 5 is an illustration of an exploded view of a third configuration of a catch basin grate.

FIG. 6 is an illustration of a bottom view of the third configuration of a catch basin grate.

FIG. 7 is an illustration of a side view of the third configuration of a catch basin grate in a street gutter.

FIG. 8 is an illustration of an exploded view of a fourth configuration of a catch basin grate.

FIG. 9 is an illustration of a bottom view of the fourth configuration of a catch basin grate.

FIG. 10 is an illustration of a side view of the fourth configuration of a catch basin grate in a street gutter.

FIG. 11A is an illustration of an exploded view of the heating element and the electrical connections to a power source.

FIG. 11B is an illustration of a side view of the heating element and the electrical connections to a power source.

FIG. 12 is an illustration of an exploded view of the control module and the electrical connections to a power source, an array of sensors, network connectivity and a circuit board comprising a microprocessor.

### DETAILED DESCRIPTION OF THE EMBODIMENTS

The following is a detailed description of certain specific embodiments of the catch basin grate is disclosed herein. In this description reference is made to the drawings.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

The term “computer-based network”, refers to a telecommunications network that allows computers to exchange data. In this aspect, networked computing devices may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of a computer network. Two such devices are said to be networked together when one device is able to exchange information with the other device, whether or not they have a direct connection to each other. The best-known computer network is the Internet. Computer networks support applications such as access to the World Wide Web and the Cloud, shared use of application and storage servers, printers, and fax machines, and use of email and instant messaging applications.

### Introduction

Disclosed herein are systems and methods by way of which a catch basin grate is equipped with an electric heating block that heats a catch basin grate to either prevent water from freezing on the grate or thaw any ice formed on the grate.

In one aspect, disclosed herein are catch basin grate covers comprising: at least one heating block and/or at least one heating rod in thermal communication with a grate cover, wherein the grate cover comprises a) a base; b) a frame; c) a grate; and d) a power source in electric communication with the at least one heating block and/or at least one heating rod, wherein the grate cover of claim 1, further comprising a control module in thermal communication and wired to the at least one heating block and/or at least one heating rod. In another aspect, disclosed herein are methods of preventing the clogging of a catch basin grate cover due to ice, the method comprising applying electricity to the heating element of the grate cover of claim 1, whereby the resulting heat from the heat element causes the ice to thaw, thereby unclogging the catch basin grate cover. In some embodiments, the catch basin grate cover further comprises that the grate cover is covering a catch basin that is connected to at least one sewer lines.

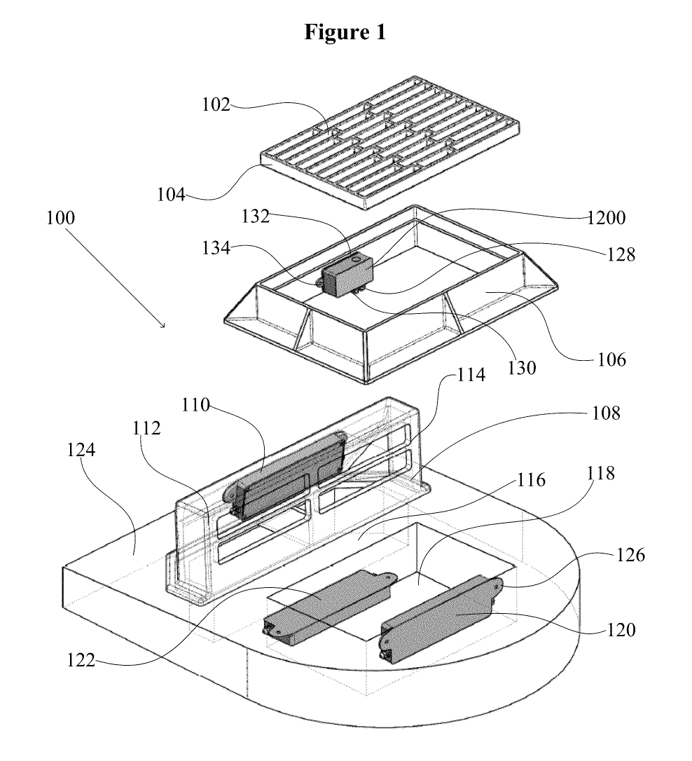

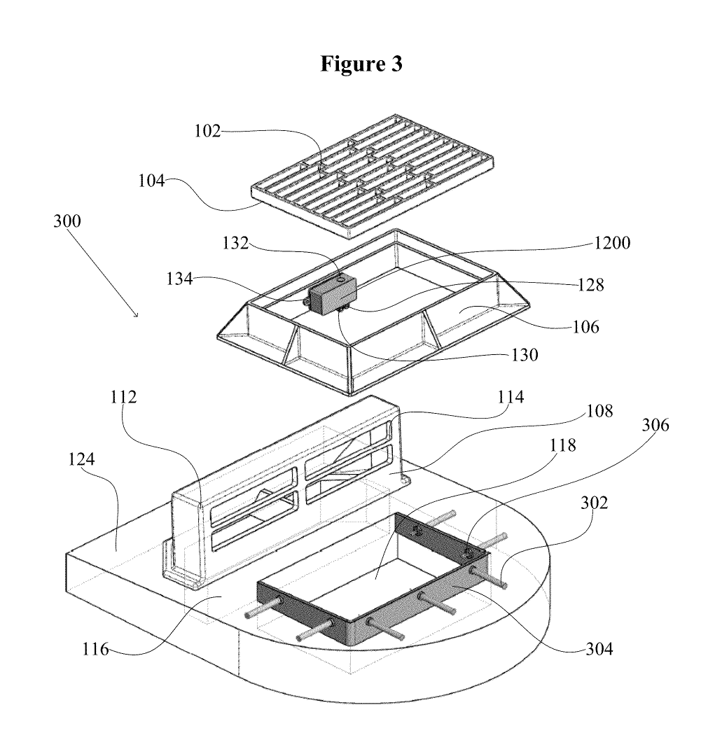

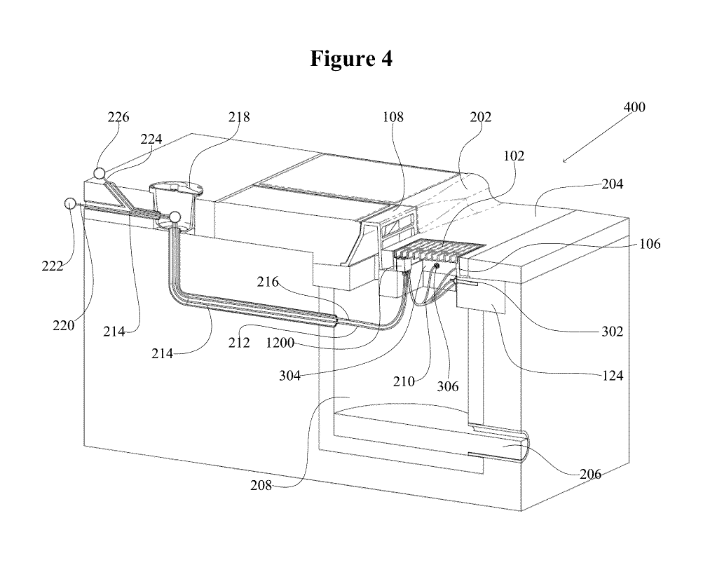

Referring to the drawings, FIGS. 1, 2, 3 and 4, illustrate an exploded view and side view of an example of a first configuration and second configuration of a catch basin gutter systems 100 and 200, and 300 and 400, respectively. The gutter systems 200 and 400 both comprise a curb 202, whose plane is generally perpendicular to the plane of the street. The gutter systems 200 and 400 also comprise a gutter 204, whose plane is generally coextensive with the plane of the street. Catch basin 208 is located under the gutter 204. The catch basin 208 is connected to the sewer lines 206 on the one side and is covered by a grate cover comprising a grate 102, a frame 104 and a base 106. In some embodiments, wherein the grate is a mesh, a plurality of square, round or oval holes, and/or square or rectangular slots. In some embodiments, the gutter system 100 and 200 comprises heating blocks 110, 120 and 122. In some embodiments, the gutter system 300 and 400 comprises heating rods 302 and heat rod frame 304. In some embodiments, heating rods 302 comprise electrical power connectors 306. In some embodiments, gutter systems 100, 200, 300 and 400 comprise a control module 1200 that is attached to the base 106 with at least one fastener 134.

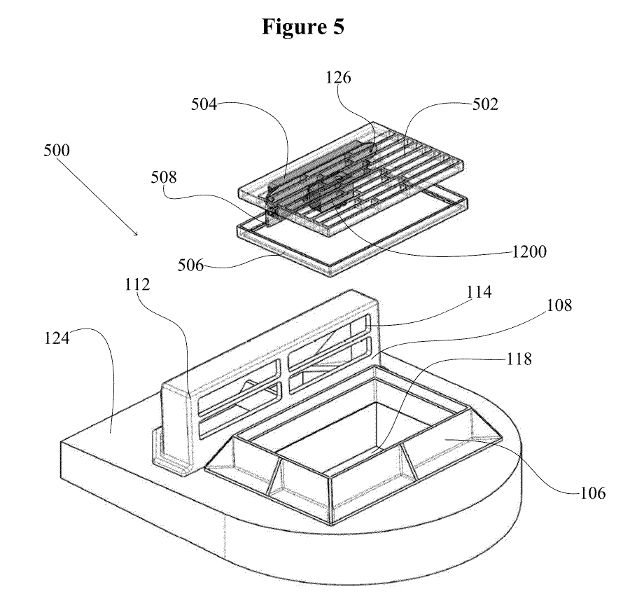

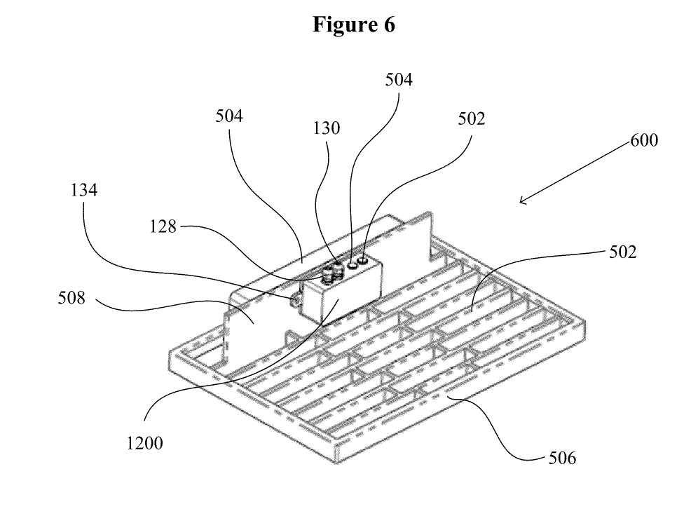

Referring to the drawings, FIGS. 5, 6 and 7, illustrate an exploded view, bottom view and side view of an example of a third configuration of a catch basin gutter system 500, 600 and 700, respectively. The gutter system 700 comprises a curb 202, whose plane is generally perpendicular to the plane of the street. The gutter system also comprises a gutter 204, whose plane is generally coextensive with the plane of the street. Catch basin 208 is located under the gutter 204. The catch basin 208 is connected to the sewer lines 206 on the one side and is covered by a grate cover comprising a grate 502, an insulating polyurethane over mould frame 506 and a base 106. In some embodiments, the gutter system 500, 600 and 700 comprises heating block 504 and a control module 1200, wherein the heating block 504 and a control module 1200 are attached on opposed faces of plate 508 with at least one fastener 126 and at least one fastener 134, respectively.

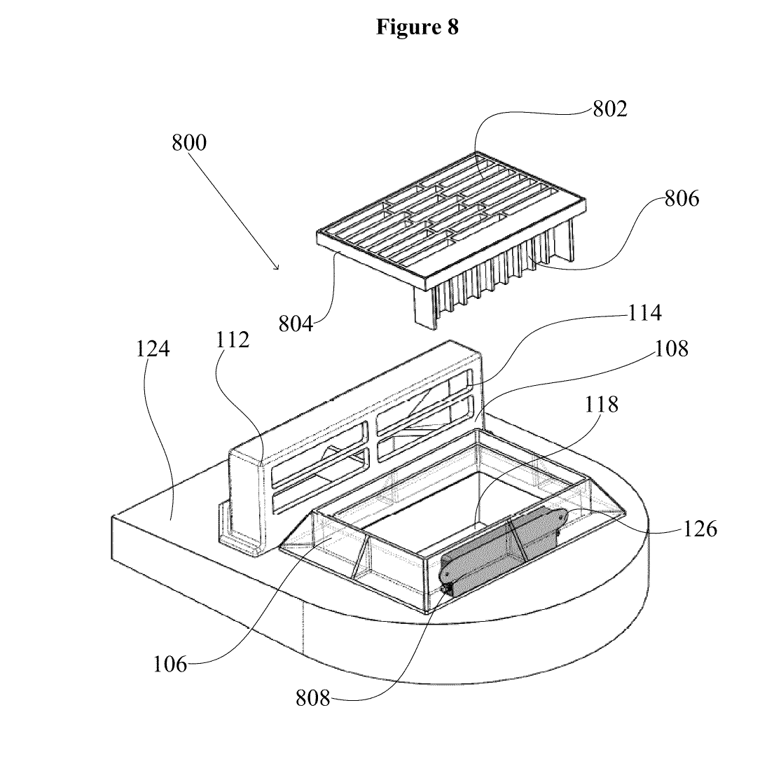

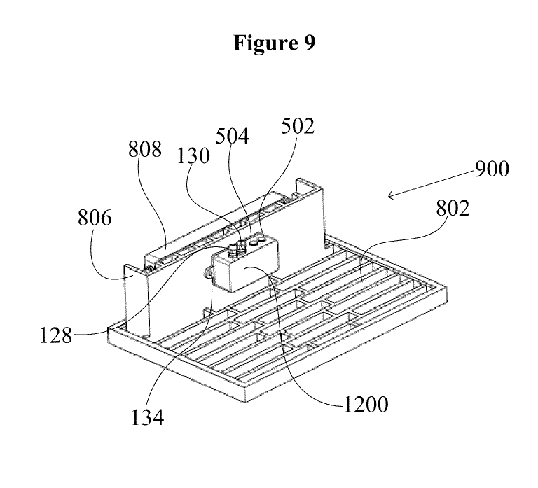

Referring to the drawings, FIGS. 8, 9 and 10, illustrate an exploded view, bottom view and side view of an example of a fourth configuration of a catch basin gutter system 800, 900 and 1000, respectively. The gutter system 1000 comprises a curb 202, whose plane is generally perpendicular to the plane of the street. The gutter system also comprises a gutter 204, whose plane is generally coextensive with the plane of the street. Catch basin 208 is located under the gutter 204. The catch basin 208 is connected to the sewer lines 206 on the one side and is covered by a grate cover comprising a grate 802, a frame 804, a heat sink 806 and a base 106. In some embodiments, a heating block 808 is attached to the base 106 or the heat sink 806 with at least one fastener 126.

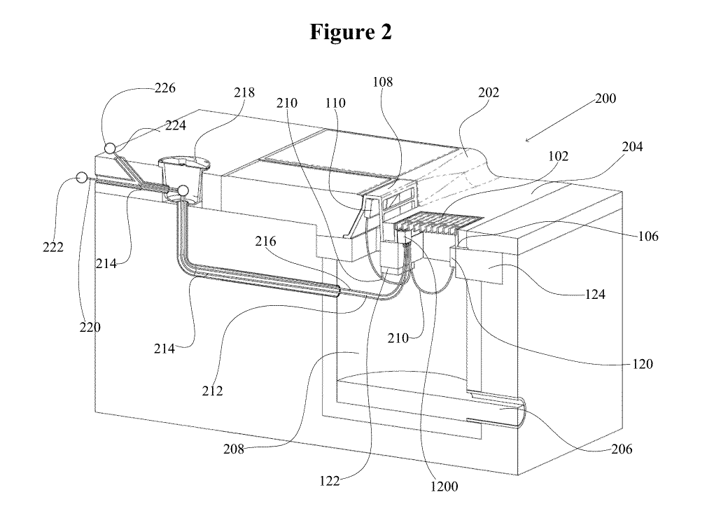

Referring to the drawings, FIGS. 1, 2, 3 and 4, illustrate the grate 102 is designed to fit in the base 106 and to allow for water to flow through the grate 102 and into the catch basin 208 via the opening 118. In some embodiments, the grate 102 is slotted. In other embodiments, the grate 102 is a mesh. In other embodiments, the grate 102 is a plate comprising a plurality of holes. In some embodiments, as depicted in FIG. 1, the base 106 is nested within a concrete slab 124. In some embodiments, as depicted in FIG. 2, the concrete slab 124 is part of the gutter 204. In other embodiments, the concrete slab 124 is separate from the gutter 204. In some embodiments, the base 106 is embedded in the concrete slab 124. In some of these embodiments, the grate 102 is removable.

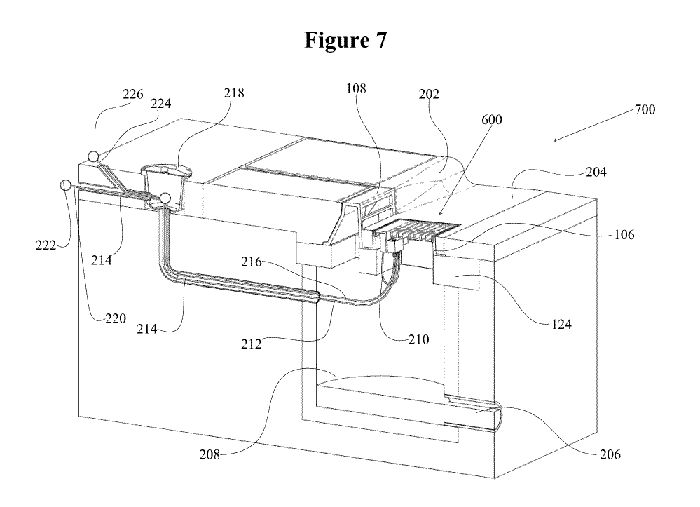

Referring to the drawings, FIGS. 5, 6 and 7, illustrate the grate 502 is designed to fit in the base 106 and to allow for water to flow through the grate 502 and into the catch basin 208 via the opening 118. In some embodiments, the grate 502 is slotted. In other embodiments, the grate 502 is a mesh. In other embodiments, the grate 502 is a plate comprising a plurality of holes. In some embodiments, as depicted in FIG. 5, the base 106 is nested within a concrete slab 124. In some embodiments, as depicted in FIG. 7, the concrete slab 124 is part of the gutter 204. In other embodiments, the concrete slab 124 is separate from the gutter 204. In some embodiments, the base 106 is embedded in the concrete slab 124. In some of these embodiments, the grate 502 is removable.

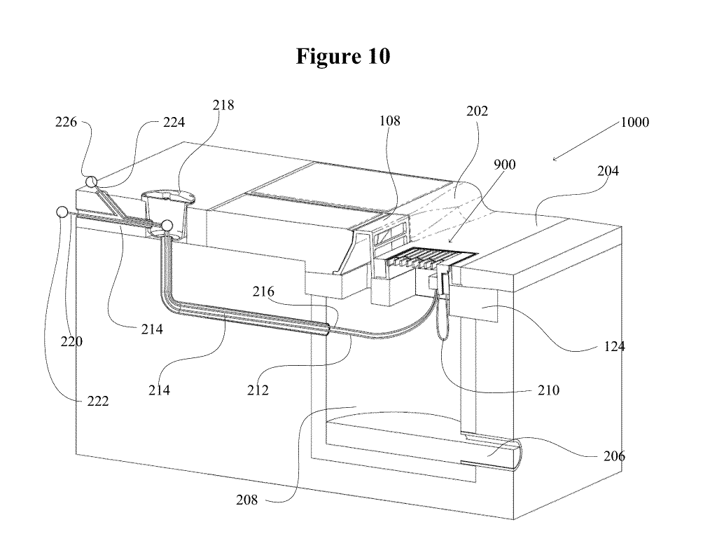

Referring to the drawings, FIGS. 8, 9 and 10, illustrate the grate 802 is designed to fit in the base 106 with the heat sink 806 and to allow for water to flow through the grate 802 and into the catch basin 208 via the opening 118. In some embodiments, the grate 802 is slotted. In other embodiments, the grate 802 is a mesh. In other embodiments, the grate 802 is a plate comprising a plurality of holes. In some embodiments, as depicted in FIG. 8, the base 106 is nested within a concrete slab 124. In some embodiments, as depicted in FIG. 10, the concrete slab 124 is part of the gutter 204. In other embodiments, the concrete slab 124 is separate from the gutter 204. In some embodiments, the base 106 is embedded in the concrete slab 124. In some of these embodiments, the grate 802 is removable.

In some embodiments, the catch basin 208 and the grate cover comprising a grate 102, a frame 104 and a base 106 are not part of a street gutter system. In this aspect, the catch basin 208 is located at a low point in a drainage basin, for example in a park, in a field, on the side of a road, in a parking lot, and the like. A catch basin not associated with a gutter system is at times called an area drain.

In some embodiments, for example with the first configuration shown in FIGS. 1 and 2, gutter system 100 comprises a storm back 108 located in the curb 202. The storm back 108 comprises a frame 112 and a grate 114. The grate 114 is analogous to the grate 102, described above. In this aspect, for water to flow through the grate 114 and into the catch basin 208 via the opening 116. In certain embodiments, the gutter system 100 does not have the storm back 108. Similarly, in some of the embodiments where the catch basin 208 is not associated with a gutter, no storm back 108 exists.

In some embodiments, for example with the first configuration shown in FIGS. 1 and 2, the grate 102, frame 104 and base 106, and the frame 112 and the grate 114 are each independently made up of a heat conducting material. In some of these embodiments, the heat conducting material is a metal. In certain embodiments, the metal is iron, steel, or a metallic alloy.

In some embodiments, for example with the first configuration as shown in FIG. 1, illustrates an exploded view of an embodiment of the grate cover comprising a grate 102, a frame 104 and a base 106. In some embodiments, the gutter system 100 comprise at least one of heating blocks 110, 120 and/or 122 that are thermal communication with a control module 1200. In some embodiments, the thermal communication is between the heating blocks 120 and/or 122 and the base 106. In other embodiments, the thermal communication is between the heating block 110 and the grate 102. In certain embodiments, the heating blocks 110, 120 and/or 122 are water proof. In some of these embodiments, the heating blocks 110, 120 and/or 122 are insulated so that there is no electrical connectivity with the environment, to avoid accidentally delivering an electric shock to passersby. In some embodiments, the heating blocks 110, 120 and/or 122 are also insulated to protect it from the elements, for example, water, ice, salt water (for winter road conditions), and/or heat (during the summer months). The use of any heating element or block that converts electrical current to heat is contemplated. In some embodiments, the catch basin grate cover further comprises a control module in thermal communication and wired to the at least one heating block and/or at least one heating rod. In some embodiments, the catch basin grate cover further comprises a control module in thermal communication and wired to the at least one heating block and/or at least one heating rod, wherein the at least one heating block and/or at least one heating rod is supplied with between about 100 and 3500 watts. In some embodiments, the catch basin grate cover further comprises a storm back comprising a storm back frame and a storm back grate in thermal communication with at least one heating block.

In some embodiments, for example with the first configuration shown in FIGS. 1 and 2, the heating blocks 120 and/or 122 are embedded in the concrete slab 124. The heat from heating blocks 120 and/or 122 is transferred by conductance through the concrete slab 124 to the base 106 and the grate 102. In other embodiments, the heating blocks 120 and/or 122 physically touch the base 106. In other embodiments, the base 106 comprises a groove into which the heating blocks 120 and/or 122 are placed.

In some embodiments, for example with the first configuration as shown in FIG. 2, the heating blocks 110, 120 and/or 122 are in electrical communication with a power source 226 through power wires 216 and 224 nested in conduits 214. In some aspects, wherein there is no junction box 218, the power wire is a combination of wires 216 and 224. In some embodiments, the power source 226 is a street light, or wires that power a street light. In other embodiments, the power source 226 is a battery. In certain embodiments, the power source 226 is a solar cell that generates electricity from sun light, and optionally stores it in a battery. In other embodiments, the power source 226 is a transformer that converts the street voltage of 110 V or 220 V to a safer voltage, for example 12 V, to avoid accidental electric shocks to passersby. Any other source of electrical energy, for example any other wire that is connected to a power source is contemplated. In some embodiments, the catch basin grate cover further comprises a control module in electric communication and wired to a junction box. In some embodiments, the catch basin grate cover further comprises a control module in electric communication and wired to a junction box, wherein the junction box is in electrical communication with a municipal electrical power grid. In some embodiments, the power source is selected from the group consisting of a street lamp, a solar cell, a battery, and a transformer. In some embodiments, the catch basin grate cover further comprises a control module is in communication with the power source via at least one power wire.

In some embodiments, for example with the first configuration shown in FIGS. 1 and 2, a control module 1200 is placed in series between the power source 226 and the heating blocks 110, 120 and/or 122. The control module 1200 is in electrical communication with the heating blocks 110, 120 and/or 122 through the wire 210, and with the power source 226 through the wires 216 and 224. The control module 1200 closes the circuit between the power source 226 and the heating blocks 110, 120 and/or 122 when the ambient temperature falls below a pre-set value, for example 32° F. (0° C.), and opens the circuit when the ambient temperature rises above the pre-set value. In some embodiments, the power source 226 comprises a municipal power grid.

In some embodiments, an analogous system as discussed above exists for the storm back 108. Thus, in FIGS. 1 and 2, frame 112 can replace base 106, and grate 114 can replace grate 102 to provide the analogous system.

In some embodiments, for example with the first configuration shown in FIGS. 1 and 2, both the grate cover comprising a grate 102, a frame 104 and a base 106 and the storm back 108 are provided. In some of these embodiments, the grate cover comprising a grate 102, a frame 104 and a base 106 and the storm back 108 comprise the heating blocks 110, 120 and 122, respectively and the connection to the power source 226. In other embodiments, the gutter system 100 comprises only one of the heating blocks 110, 120 and 122 and the connection to the power source 226.

In some embodiments, for example with the first configuration as shown in FIG. 2, wherein both the grate cover comprising a grate 102, a frame 104 and a base 106 and the storm back 108 comprise the heating blocks 110, 120 and 122 and the heating blocks have a wired connection to the power source 226. Thus, both the grate cover and the storm back 108 connect to the power source 226 through the power wires 210. In these embodiments, the wire 210 splits, optionally distal to the control module 1200, and one set of wires connects with heating blocks 120 and 122 and another set of wires connects with heating block 110. In other embodiments, each of the heating blocks 110, 120 and 122 connect with the power source 226 independently. In some of these embodiments, the flow of electricity into each of the heating blocks 110, 120 and 122 is optionally and independently regulated by the control module 1200.

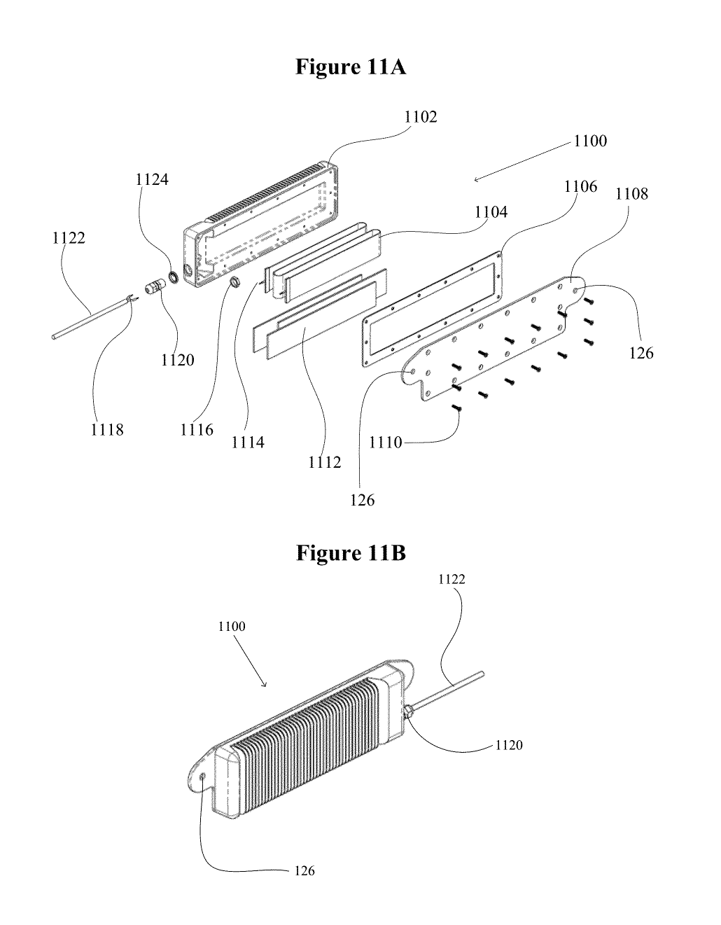

Referring to the drawings, FIGS. 11A and 11B, the heating block 1100 comprises a main heating block housing 1102; heating tape/ribbon 1104; heating tape/ribbon spacer 1112; heating tape/ribbon connectors 1114; enclosure gasket 1106; enclosure cover 1108; heating block fasteners 126; main housing enclosure screws 1110; strain relief gasket 1124; cable strain relief connector with seal 1120; a heater power cable 1122 with connector; and a strain relief nut 1116.

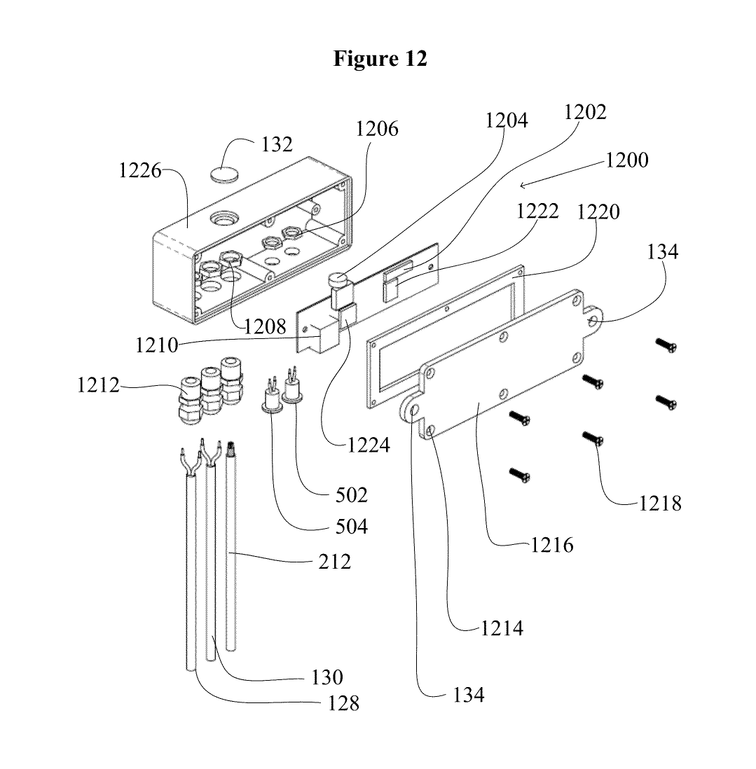

In some embodiments, as depicted in FIG. 12 the control module 1200 comprises a power regulator 1210; a wireless module 1222; wireless antenna 1202; a microprocessor 1224; a photo cell 1204; a photo cell lens 132 for sealing the photo cell opening; a control module main housing 1226; strain relief connectors 1212; a power wire from junction box 128; a power wire to heater blocks 130; a first network cable 212; a second network cable 220; strain relief nuts 1208; a humidity sensor 504; a temperature sensor 502; a main housing gasket 1220; a main housing cover mounting holes 1214; and main housing cover mounting screws 1218. In some embodiments, the control module 1200 is in communication with a computer-based network 222 via the network cables 212 and 220. In some aspects, wherein there is no junction box 218, the network cable is a combination of network cables 212 and 220. In some embodiments, the catch basin grate cover further comprises a control module is in communication with a computer-based network via at least one network cable. In some embodiments, the catch basin grate cover further comprises a control module that is in communication with a computer-based network. In some embodiments, the catch basin grate cover further comprises a control module is in communication with a computer-based network via a wireless connection. In some embodiments, the flow of electricity into each of the heating blocks is regulated by the computer-based network via a network connection to the control module 1200.

In some embodiments, a sacrificial anode is provided to prevent the corrosion of the grate cover, its frame, and/or its grate.

The presently disclosed catch basin grates are not to be limited in scope by the specific embodiments described herein, which are intended as single illustrations of individual aspects of the presently disclosed catch basin grates, and functionally equivalent methods and components are within the scope of the presently disclosed catch basin grates. Indeed, various modifications of the presently disclosed catch basin grates, in addition to those shown and described herein will become apparent to those skilled in the art from the foregoing description and accompanying drawings. Such modifications are intended to fall within the scope of the appended claims.

What is claimed is:

1. A catch basin grate cover comprising: at least one heating block and/or at least one heating rod in thermal communication with a grate cover, wherein the grate cover comprises
a) a base;
b) a frame;
c) a grate; and
d) a power source in electric communication with the at least one heating block and/or at least one heating rod.

2. The grate cover of claim 1, further comprising a control module in thermal communication and wired to the at least one heating block and/or at least one heating rod.

3. The grate cover of claim 1, further comprising a control module in electric communication and wired to a junction box.

4. The grate cover of claim 1, further comprising a control module in electric communication and wired to a junction box, wherein the junction box is in electrical communication with a municipal electrical power grid.

5. The grate cover of claim 1, wherein the power source is selected from the group consisting of a street lamp, a solar cell, a battery, and a transformer.

6. The grate cover of claim 1, further comprising a control module is in communication with the power source via at least one power wire.

7. The grate cover of claim 1, further comprising a control module that is in communication with a computer-based network.

8. The grate cover of claim 1, further comprising a control module that is in communication with a computer-based network.

9. The grate cover of claim 1, further comprising a control module is in communication with a computer-based network via at least one network cable.

10. The grate cover of claim 1, further comprising a control module is in communication with a computer-based network via a wireless connection.

11. The grate cover of claim 1, further comprising a control module in thermal communication and wired to the at least one heating block and/or at least one heating rod.

12. The grate cover of claim 1, further comprising a control module in thermal communication and wired to the at least one heating block and/or at least one heating rod, wherein the at least one heating block and/or at least one heating rod is supplied with between about 100 and 3500 watts.

13. The grate cover of claim 1, wherein the grate is a mesh, a plurality of square, round or oval holes, and/or square or rectangular slots.

14. The grate cover of claim 1, further comprising a storm back comprising a storm back frame and a storm back grate in thermal communication with at least one heating block.

15. The grate cover of claim 1, further comprising that the grate cover is covering a catch basin that is connected to at least one sewer lines.

16. A catch basin grate cover comprising: at least one heating block and/or at least one heating rod in thermal communication with a grate cover, wherein the grate cover comprises
a) a base;
b) a frame;
c) a grate; and
d) a means for heating the grate cover; and
e) means for supplying power to the means for heating.

17. A method of preventing the clogging of a catch basin grate cover due to ice, the method comprising applying electricity to the heating element of the grate cover of claim 1, whereby the resulting heat from the heat element causes the ice to thaw, thereby unclogging the catch basin grate cover.
